(19) United States
(12) Patent Application Publication
(10) Pub. No.: US 2006/0139555 A1
(43) Pub. Date: Jun. 29, 2006

(54) Double seal with getter in flexible organic displays

(76) Inventors: Esther Anna Wilhelmina Gerarda Janssen, Eindhoven (NL); Maarten Dirkzwager, Eindhoven (NL); Hans Zuidema, Eindhoven (NL); Eduard Van Veenen, Eindhoven (NL); Giovanni Nisato, Eindhoven (NL); Cornelis Adrianus Henricus Antonius Mutsaers, Eindhoven (NL); Oscar Johannes Antoinetta Buijk, Eindhoven (NL); Petrus Cornelis Paulus Bouten, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/560,635

(22) PCT Filed: Jun. 9, 2004
(86) PCT No.: PCT/IB04/50867

§ 371 Date: Dec. 13, 2005

(30) Foreign Application Priority Data
Jun. 16, 2003 (EP) 03101754.4

(51) Int. Cl. G02F 1/1339

(52) U.S. Cl. 349/153

(57) ABSTRACT

Improved seal for flexible organic light emitting displays are provided. For the purpose of the present invention it is realisd that a homogenous seal cannot provide for the combination of resuired robusness and required impermeability, which are essential for the life time of the display. Therefore, a seal comprising an inner seal portion and an outer seal portion is proposed. The outer seal portion is flexible as compared to the inner seal portion and the inner seal portion is impermeable as compared to the outer seal portion and being deposited between the outer seal portion and the display element.

### FIELD OF THE INVENTION

The present invention relates to flexible organic displays.

### TECHNOLOGICAL BACKGROUND

Flexible displays are a great challenge towards new markets. Basically, flexible displays can be manufactured using known display elements, e.g. Liquid Crystal Display (LCD) elements or Organic Light Emitting Display (OLED) elements, deposited on flexible substrates, e.g. polymer substrates. For example, Philips has demonstrated a flexible display based on liquid crystal materials. The use of light emitting polymers offers the advantage of excellent viewing angle, contrast and low power consumption. Flexible passive matrix monochrome organic light emitting displays (OLEDs) have been demonstrated by US and Far East companies, such as Pioneer, Dai Nippon, UDC, and DuPont Displays.

Generally, an OLED comprises an organic display element which is deposited on a base glass substrate and covered by an exit substrate. One of the critical issues for Organic Light Emitting Devices (OLEDs) is their lifetimes, which is largely limited by the degradation of the organic light emitting material induced by water and oxygen inside the display. Therefore, the packaging of the display element is critical. In order to provide for a gas tight encapsulation of the display element, the substrates are joined together by a seal impermeable to water and/or oxygen. Furthermore, the displays are usually assembled in inert gas conditions, in order to eliminate any contamination from being contained in the display. However, there is always a risk for some trace amounts of oxygen or water to remain in the display cell and the seals are not 100% impermeable to moisture and gas. Therefore, packaging of polyLED devices deposited on glass currently involves gluing a rigid lid with getter on the glass substrate, which absorbs excess water and or gaseous substances in the display. However, even using getter the impermeability requirements for the seals are high.

Typically, seals are formed out of organic materials. Basically there are two ways to increase the impermeability of such materials, either a filler is added or the organic backbone of the material is changed. However, both approaches result not only in increased impermeability, but also in reduced flexibility (i.e. increased young's modulus). In rigid displays this is not a problem since the flexibility of the seal is not an issue. However, when it comes to flexible displays the seals need to be flexible enough not to fracture when bending the display.

Actually, the seals in flexible displays are exposed to a number of loads when the display is bent. First, the material in the seal itself is of course bent, giving rise to internal stress in the material. Second, and even worse, the seal material is exposed to a shear force which is due to the spatial separation of the base and exits substrates. Third, unless the substrates are extremely flexible, the seal will experience a tensile force as the substrates inherently want to become straight again. Using prior art, rigid seals for flexible displays therefore results in gas leakages due to the substrates delaminating and the seal material fracturing. Therefore, there is a need for flexible displays having improved seals.

### SUMMARY OF THE INVENTION

It is therefore an object of the present invention to provide flexible displays having improved seals.

This object is accomplished by the inventive display device as defined in claim 1. The appended sub-claims provide advantageous embodiments of the invention. Further objects and advantages will be apparent from the following description.

The present invention thus provides a flexible organic light emitting display element, comprising a flexible back plate substrate, a flexible cover substrate, a seal, an active display element which is deposited on said flexible back plate substrate wherein said back plate and cover substrates are joined together by said seal so as to encapsulate said active display element, and wherein said seal comprises an inner seal portion and an outer seal portion, the outer seal portion being flexible as compared to the inner seal portion and the inner seal portion being impermeable as compared to the outer seal portion and being deposited between the outer seal portion and the display element.

The inner seal portion is designed to provide for the required impermeability, and is thus made relatively rigid. Using only such a seal, the arrangement would readily delaminate and fracture when bent. However, combining the inner, rigid seal with an outer, flexible seal portion provides for the required robustness. The strength in such an outer seal portion is surprisingly not only enough to secure the substrate joint when bent, but also to substantially reduce the tendency of the rigid inner seal portion to fracture. This is crucial, since any fractures in the inner seal portion would create gas leakages through the entire seal even if the outer seal portion is still unbroken. This is so due to the permeability of the outer seal portion, which in turn is a consequence of the flexibility requirements.

It has thus been found that the inventive composite seal provides for substantially increased structural strength in the assembly. The flexible outer seal distributes the stresses that occur due to bending of the display. The resulting stress distribution thus lowers the tensile force between the substrates and therefore decreased the risk for substrate delamination.

A square display device being 30 mm times 30 mm in size typically has a total seal width of 2 mm (range 0.5-5 mm), a seal height of 0.01 mm (range 0.003-0.1 mm) and a total seal length of 120 mm. In the inventive seal, the inner and outer seal portions preferably have about the same width. The substrates typically are 0.1 mm thick.

The seal preferably has a permeability below 5*10⁻⁵ g water/m²/day, and even more preferably below 1*10⁻⁵ g water/m²/day. It has been found that this requirement is sufficient to provide a satisfactory life time for the device.

The inner seal portion preferably is formed out of a material having a young's modulus higher than 1 GPa, and even more preferably higher than 2 GPa. As it appears, this stiffness is a necessary consequence of the required impermeability.

The outer seal portion is preferably formed out of a material having a young's modulus lower than 50 MPa, and even more preferably lower than 10 MPa. Materials being this flexible provides for the robustness necessary to avoid substrate delaminations and fractures in the inner seal portion when the display is bent.

Regarding the stiffness of the materials in the inner and outer seal portions, it has been found that a ratio between their respective young's modulii advantageously is between 1/100-1/1000 for many applications. The inventive seals are experienced to be at least as impermeable as the prior art rigid display seals, thus providing flexible displays having at least the same life time endurance.

For the purpose of the present invention it is thus realisd that a homogenous seal cannot provide for the combination of resuired robusness and required impermeability, which are essential for the life time of the display. Therefore, a seal comprising an inner seal portion and an outer seal portion is proposed. The outer seal portion is flexible as compared to the inner seal portion and the inner seal portion is impermeable as compared to the outer seal portion and being deposited between the outer seal portion and the display element.

### BRIEF DESCRIPTION OF THE DRAWINGS

In the following vrious embodiments of the present invention will be further described with reference to the accomanying drawings, on which:

FIG. 1 shows a cross section of a prior art rigid display, having a homogenous seal.

FIG. 2 shows cross section of an inventive, flexible display having a composite seal.

FIG. 3 shows a top view as well as a cross section of an inventive display.

FIG. 4 shows an inventive display as well as magnified cross sections indicating the stress distribution in an inventive seal as compared to a homogenous seal.

FIG. 5-7 shows the stress distribution for various seal compositions in flexible displays.

### EMBODIMENTS OF THE INVENTION

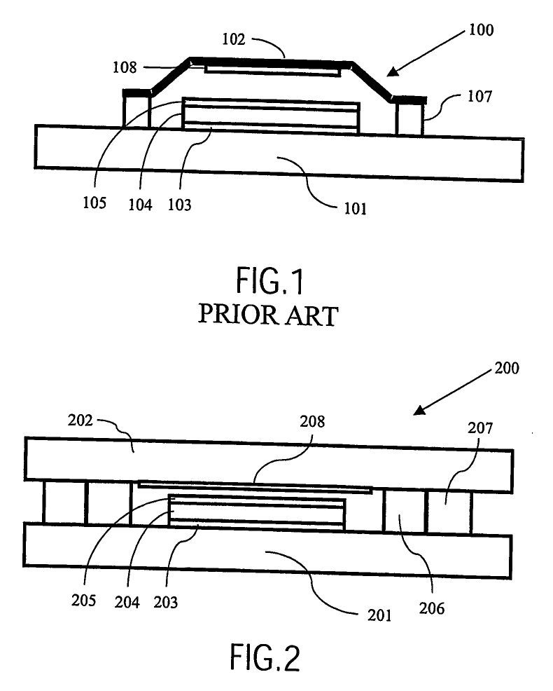

FIG. 1 shows a cross section of a rigid, prior art display 100. The display comprises a back plane 101 on which an organic light emitting polymer 104 is arranged between an anode 103 and a cathode 105. A metallic back cover 102 is spaced apart from the back plane by means of seals 107 thus forming a closed display cell. Finally, a getter 108 is arranged on the metallic lid 102 inside the display cell. In FIG. 1 as well as in the following figures, the seals have a exaggerated thickness in order to increase readability. The substrates in a typical display device can for example be about 0.1 mm thick and the seals can be about 0.01 mm, the seals thus being substantially thinner than the substrates.

FIG. 2 shows a cross section of an inventive, flexible display 200 having an inner seal portion 206 and an outer seal portion 207 encapsulating the display cell. Both the back plane 201 and the cover substrate 202 are formed out of a flexible material, for example a polycarbonate or a polyester. The display element is similar to prior art displays, thus including an anode 203, a layer 204 of an organic light emitting material and a cathode 205. The active display element is driven via interconnection lines that are fed underneath the seal to the driving electronics outside the display device. These components are however similar to conventional OLEDs and are not shown in the figure.

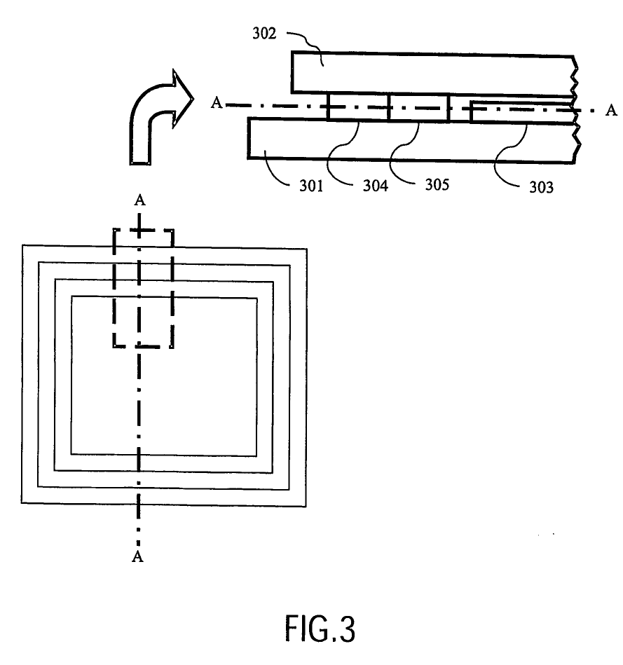

FIG. 3 schematically shows a top perspective of an inventive display 300, as well a cross section along A-A. The display thus comprises a back plane 301, a cover substrate 302, and a display element 303. Also shown is the inventive double seal, comprising an inner seal portion 305 and an outer seal portion 304.

According to one embodiment, the flexible seal has a young's modulus of 8 MPa and the rigid seal portion has a young's modulus of 2 GPa.

The required water vapour transmission (permeability) rate for organic PLED devices should be lower than 0.00005 g/m²/day and preferably lower than 0.00001 g/m²/day. The permeability can be measured using the so-called Ca-test, developed by Philips and based on the optical detection of the degradation of metals (Calcium) sensitive to oxygen and water.

The seal materials that are concidered sofar are Delo 3033 with a modulus of 2 GPa and Delo 30F220F with a modulus of 8 MPa (both available from the german company DELO Industrie Klebstoffe), thus providing a young's moduli ration of 1/250. In comparsion, prior art impermeable seals typically has a modulus of 4 GPa. However, as readily realised by the skilled man, there are noumerous possible organic materials for the seal portions, including thermally curing or UV-curing epoxies, hybrid epoxies and acrylates.

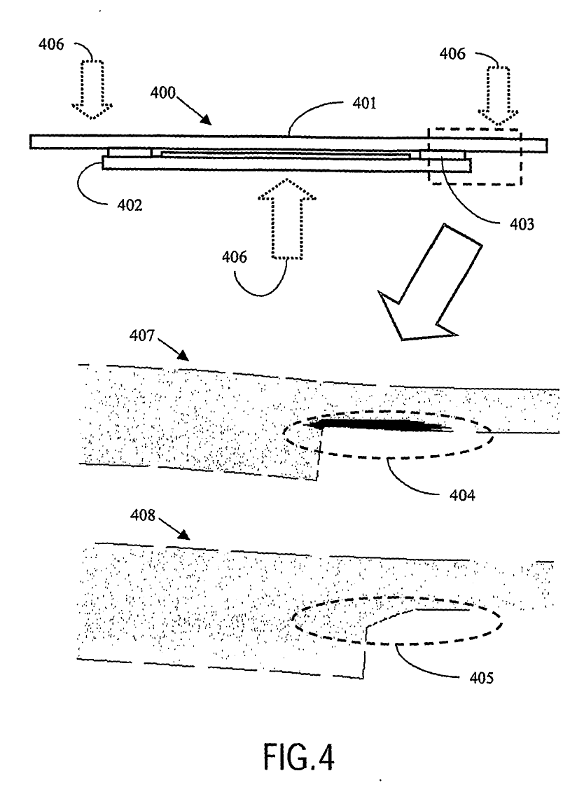

FIG. 4 schematically shows a flexible display 400 being exposed for forces, indicated by the arrows 406. Also shown is enlarged portions 407, 408 showing in detail a seal exposed for the corresponding stress. Portions 407 shows the stress distribution in a prior art seal, having a homogeneous rigid seal. The black area 404 indicates the region where the stress is above the strength of the material and the seal will therefore fracture, and the gray areas indicate areas where the stress is below the strength threshold value. In comparison, portion 408 shows an inventive seal, comprising an inner, rigid seal portion and an outer, flexible seal portion according to the invention. The seal is exposed for exactly the same stress distribution as portion 407. As can be seen, nowhere is the stress above the strength threshold value of the seal, and therefore no fractures will appear.

In general, inventive displays can be manufactured much the same as prior art flexible OLEDS the only difference being the seal arrangement. Active organic device layers are thus deposited on a flexible back plane substrate in a number of consecutive front end process steps. After the front end processing, the back plane is transferred to a glove box containing an inert, dry nitrogen gas environment suitable for performing back end processing steps including depositing a cathode on the active device and packing the display. To this end a rigid seal having a young's modulus after curing of 2 GPa is dispensed on a flexible cover substrate outside the glove box. Thereafter a flexible seal having a young's modulus after curing of 8 MPa is dispensed next to and on the outside of the rigid seal. The cover substrate with the uncured double seal lines is then transferred via a vacuum chamber to the nitrogen box. The back plane and cover substrate are accurately aligned and coupled in a controlled way, and the seals are finally cured by UV-light. The finally sealed devices can now be removed from the glove box.

### EXPERIMENT

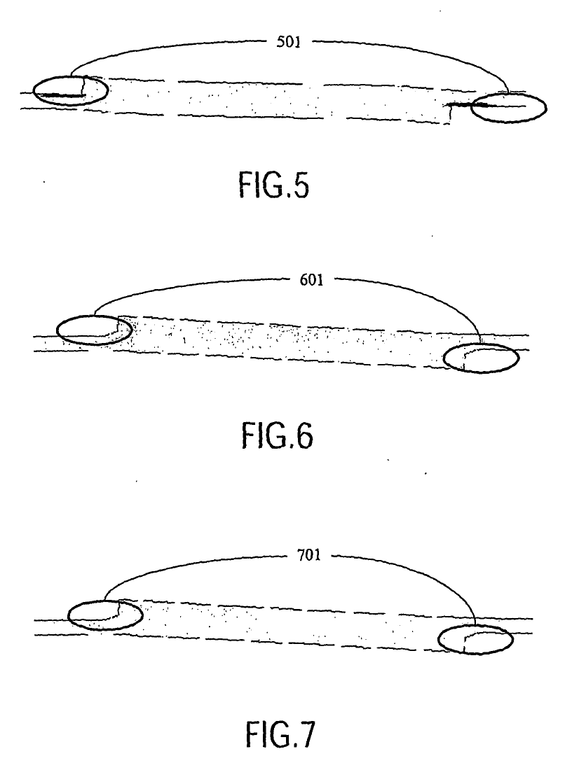

A system of two thin, flexible substrates sealed together with a thin adhesive layer was used for a qualitative analysis. This so-called lap-shear test was used in a finite element modelling analysis. FIG. 4 shows the stress state of this system in shear tension, for an adhesive layer having a high young's modulus. The stress reached a maximum at the end of the seal line as shown by the black 501 portion in FIG. 5. The risk for delamination was consequently high in this case. The same lap-shear test was subsequently performed using a flexible adhesive layer (with accompanying low modulus), and the resulting stress state of the system in shear tension is shown in FIG. 6. The high stress level present at both ends of the substrate decreased gradually along the seal line in the joint. As can be seen, the critical region 601 is no more exposed for a too high stress level. Consequently, no high stress was present near the seal line and the risk for delamination was substantially reduced. A combination of a rigid (high modulus) and a flexible (low modulus) seal in this lap-shear test thus appeared to combine the best of both alternatives, i.e. robustness and impermeability. The calculated stress for a combined seal (in this case symmetric: high modulus inside and low modulus outside) is shown in FIG. 7. The flexible seal on the outside distributes the stress and diminishes the peeling stress at both ends of the seal. The inventive seal composition comprising a flexible and a rigid seal portion thus provided similar stress distribution as for a homogenous, flexible seal. Of course, using only such a flexible seal would not provide for the required impermeability which indeed is provided for by the inventive, composite seal.

1. A flexible organic light emitting display element, comprising a flexible back plate substrate, a flexible cover substrate, a seal, an active display element which is deposited on said flexible back plate substrate wherein said back plate and cover substrates are joined together by said seal so as to encapsulate said active display element, and wherein said seal comprises an inner seal portion and an outer seal portion, the outer seal portion being flexible as compared to the inner seal portion and the inner seal portion being impermeable as compared to the outer seal portion and being deposited between the outer seal portion and the display element.

2. A display element according to claim 1, wherein the inner seal portion has a lower permeability than the outer seal portion.

3. A display element according to claim 1, wherein the seal has a permeability below 5*10⁻⁵ g water per square meter per day.

4. A display element according to claim 1, wherein the inner seal portion is formed of a material having a young's modulus higher than 1 GPa.

5. A display element according to claim 1, wherein the inner seal portion is formed of a material having a young's modulus higher than 2 GPa.

6. A display element according to claim 1, wherein the outer seal portion is formed of a material having a young's modulus lower than 50 MPa.

7. A display element according to claim 1, wherein the outer seal portion is formed of a material having a young's modulus lower than 10 MPa.

8. A disaply element according to claim 1, wherein a ratio of young's modulus of inner seal and outer seal material, respectively, is between 1/100 to 1/1000.
